(19) United States
(12) Patent Application Publication
(10) Pub. No.: US 2007/0077957 A1
(43) Pub. Date: Apr. 5, 2007

(54) Apparatus, method and computer program product providing HS-DSCH power estimate

(75) Inventor: Klaus Ingemann Pedersen, Aalborg (DK)

Correspondence Address: HARRINGTON & SMITH, PC, 4 RESEARCH DRIVE, SHELTON, CT, 06484-6212, US

(73) Assignee: Nokia Corporation

(21) Appl. No.: 11/523,312

(22) Filed: Sep. 18, 2006

Related U.S. Application Data
(60) Provisional application No. 60/718,530, filed on Sep. 19, 2005.

(51) Int. Cl. H04B 7/00

(52) U.S. Cl. 455/522

(57) ABSTRACT

The exemplary embodiments of this invention provide in one aspect thereof a method that comprises assuming that a user k is scheduled in M transmission time intervals during a radio resource indication period of N transmission time intervals, where M≦N, where an effective average power used by the user k is expressed as:

$${P}_{k} = \frac{1}{N} {\sum }_{m = 1}^{M} {P}_{k}^{′} ( m ) ,$$

where P′ₖ(m) denotes the transmit power that is used by user k for each of the M transmission time intervals where user k is scheduled; and estimating a required downlink shared channel power for a scheduling priority indicator number x so as to fulfill a guaranteed bit rate as:

$${P}_{SPI} ( x ) = {\sum }_{k ∈ SPI ( x )} {P}_{k} \frac{{GBR}_{k}}{{RB}_{k}} ,$$

where RBₖ is an average bit rate supported to the user k over a past radio resource indication period, GBRₖ is a guaranteed bit rate for the user k, and SPI(x) is a set of users that have SPI=x.

This patent application claims priority under 35 U.S.C. 119 from copending U.S. Provisional Patent Application No.: 60/718,530, filed Sep. 19, 2005, the content of which is incorporated by reference herein in its entirety.

### TECHNICAL FIELD

The exemplary embodiments of this invention relate generally to cellular communications systems, methods, devices and computer programs and, more specifically, relate to techniques for providing power estimations.

### BACKGROUND

The following abbreviations, at least some of which appear in the description below, are defined as follows:
3GPP third generation partnership project
DL downlink
DPCH dedicated physical channel
GBR guaranteed bit rate
HSDPA high-speed downlink packet access
HS-DPCCH high-speed dedicated physical control channel
HS-DSCH high-speed downlink shared channel
HS-SCCH high-speed shared control channel
MAC medium access control
MAC-hs MAC high speed
QoS quality of service
RNC radio network controller
RRI radio resource indication
SPI scheduling priority indicator
TTI transmission time interval
Node-B base station
UE user equipment
UL uplink
UMTS universal mobile telecommunications system C304
UTRAN UMTS terrestrial radio access network
WCDMA wideband code division multiple access

The 3GPP Release'5 specifications have defined optional reporting from the Node-B of the HS-DSCH required power, where the HS-DSCH required power is the necessary transmit power per priority class (SPI group) that is required to meet the GBR for that group of allocated HSDPA users. Reference may be made to 3GPP TS 25.433 V6.6.0 (2005-06),.3rd Generation Partnership Project; Technical Specification Group Radio Access Network; UTRAN Iub interface Node B Application Part (NBAP) signalling (Release 6), in particular sections 9.2.1.31Iba, HS-DSCH Required Power Value (see FIG. 2A herein) and section 9.2.1.3Ic, HS-DSCH Required Power Value Information (see FIG. 2B herein). The HS-DSCH Required Power Value Information Element (IE) reports the HS-DSCH Required Power Value IE for each priority class. For each priority class, a list of UEs, identified by the CRNC Communication Context TEs, requiring a particularly high amount of power to meet the Guaranteed Bit Rate for their established HS-DSCH connections, may be included. Additionally, the HS-DSCH Required Power Per UE Weight IE may be included for each of those UEs.

However, the 3GPP specifications do not specify how the Node-B should estimate the HS-DSCH required power.

### SUMMARY

The exemplary embodiments of this invention provide in one aspect thereof a method that comprises assuming that a user k is scheduled in M transmission time intervals during a radio resource indication period of N transmission time intervals, where M≦N, where an effective average power used by the user k is expressed as:

$${P}_{k} = \frac{1}{N} {\sum }_{m = 1}^{M} {P}_{k}^{′} ( m ) ,$$

where P′ₖ(m) denotes the transmit power that is used by user k for each of the M transmission time intervals where user k is scheduled; and estimating a required downlink shared channel power for a scheduling priority indicator number x so as to fulfill a guaranteed bit rate as:

$${P}_{SPI} ( x ) = {\sum }_{k ∈ SPI ( x )} {P}_{k} \frac{{GBR}_{k}}{{RB}_{k}} ,$$

where RBₖ is an average bit rate supported to the user k over a past radio resource indication period, GBRₖ is a guaranteed bit rate for the user k, and SPI(x) is a set of users that have SPI=x.

The exemplary embodiments of this invention provide in another aspect thereof a computer program product stored in a tangible memory medium that comprises program instructions, the execution of which by a data processor result in operations comprising, for an assumption that a user k is scheduled in M transmission time intervals during a radio resource indication period of N transmission time intervals, where M≦N, where an effective average power used by the user k is expressed as:

$${P}_{k} = \frac{1}{N} {\sum }_{m = 1}^{M} {P}_{k}^{′} ( m ) ,$$

where P′ₖ(m) denotes the transmit power that is used by user k for each of the M transmission time intervals where user k is scheduled; estimating a required downlink shared channel power for a scheduling priority indicator number x so as to fulfill a guaranteed bit rate as:

$${P}_{SPI} ( x ) = {\sum }_{k ∈ SPI ( x )} {P}_{k} \frac{{GBR}_{k}}{{RB}_{k}} ,$$

where RBₖ is an average bit rate supported to the user k over a past radio resource indication period, GBRₖ is a guaranteed bit rate for the user k, and SPI(x) is a set of users that have SPI=x.

The exemplary embodiments of this invention provide in yet another non-limiting aspect thereof an apparatus that comprises a wireless network node having an interface for coupling to a plurality of user devices and further including circuitry responsive to an assumption that a user k is scheduled in M transmission time intervals during a radio resource indication period of N transmission time intervals, where M≦N, where an effective average power used by the user k is expressed as:

$${P}_{k} = \frac{1}{N} {\sum }_{m = 1}^{M} {P}_{k}^{′} ( m ) ,$$

where P′ₖ(m) denotes the transmit power that is used by user k for each of the M transmission time intervals where user k is scheduled, to estimate a required downlink shared channel power for a scheduling priority indicator number x so as to fulfill a guaranteed bit rate as:

$${P}_{SPI} ( x ) = {\sum }_{k ∈ SPI ( x )} {P}_{k} \frac{{GBR}_{k}}{{RB}_{k}} ,$$

where RBₖ is an average bit rate supported to the user k over a past radio resource indication period, GBRₖ is a guaranteed bit rate for the user k, and SPI(x) is a set of users that have SPI=x.

### BRIEF DESCRIPTION OF THE DRAWINGS

In the attached Drawing Figures:

FIG. 1 shows a simplified block diagram of various electronic devices that are suitable for use in practicing the exemplary embodiments of this invention.

FIG. 2A shows a table from 3 GPP TS 25.433, section 9.2.1.31 Iba, HS-DSCH Required Power Value, while FIG. 2B shows a table from 3GPP TS 25.433, section 9.2.1.3Ic, HS-DSCH Required Power Value Information.

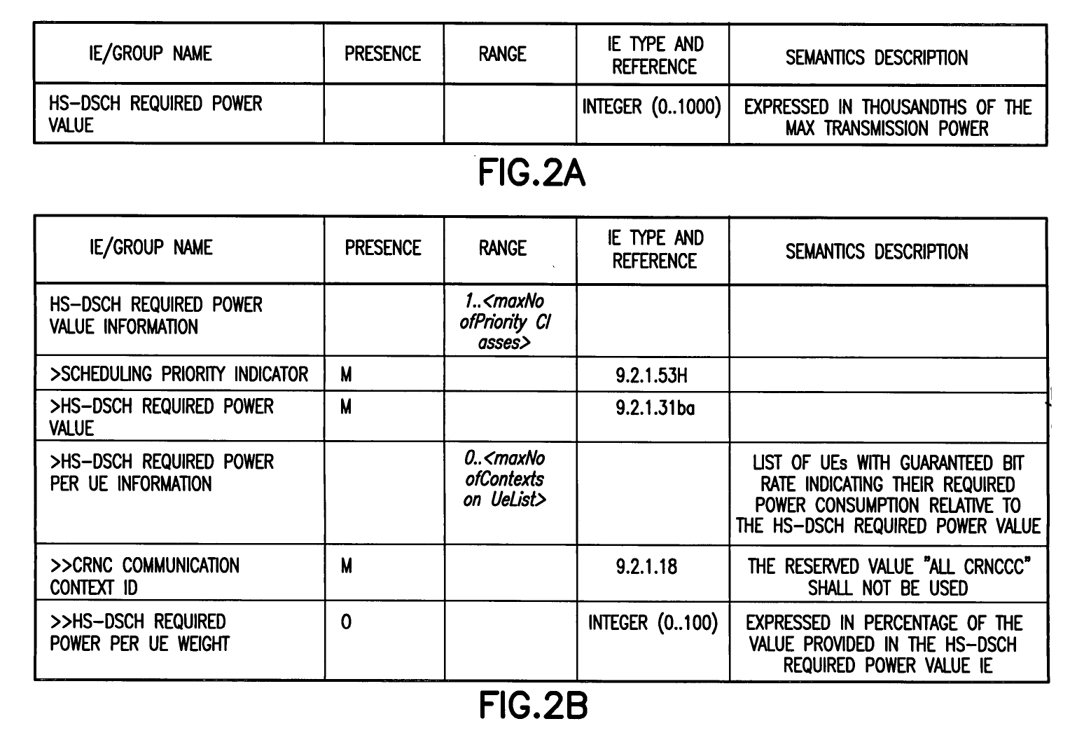

FIG. 3 is a logic flow diagram that is descriptive of a method, and of the operation of a computer program product, in accordance with the exemplary embodiments of this invention.

### DETAILED DESCRIPTION

The exemplary embodiments of this invention pertain at least in part to HSDPA in WCDMA, and provide a technique for the Node-B to estimate the HS-DSCH required power for a set of attached HSDPA users. The use of the exemplary embodiments of this invention does not require changes to existing 3GPP Release'5 specifications. The exemplary embodiments of this invention may be used, as a non-limiting example, by quality-based HSDPA access algorithms

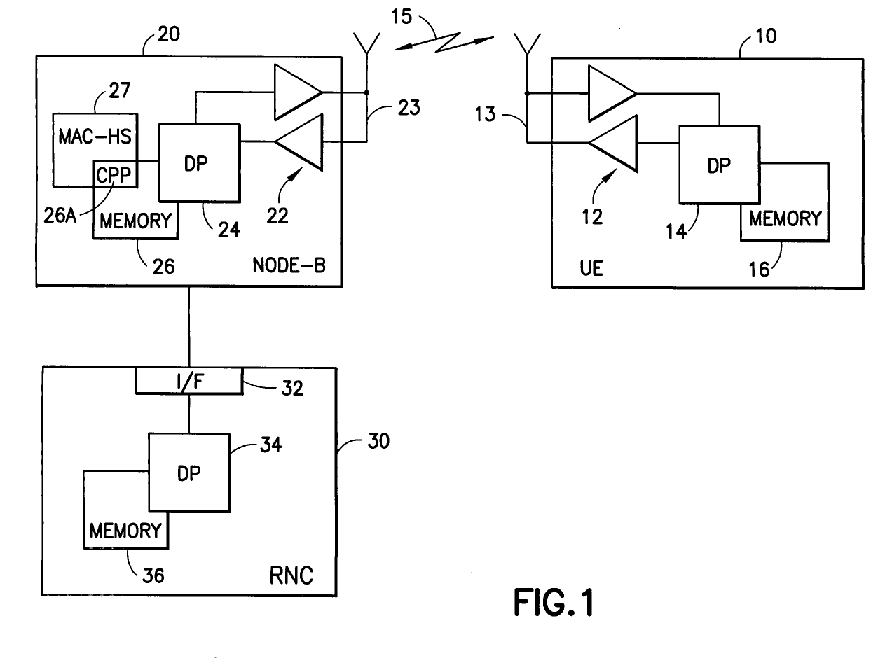

Reference is made first to FIG. 1 for illustrating a simplified block diagram of various electronic devices that are suitable for use in practicing the exemplary embodiments of this invention, specifically a HSDPA terminal 10, also referred to as User Equipment (UE) 10, and a wireless network node embodied by example as a Node-B 20. As used herein, but not as a limitation on the practice of the exemplary embodiments of this invention, the Node-B 20 may be assumed to be functionally equivalent to a 3GPP 25-series specification term Node-B. The Node-B 20 is shown coupled to another wireless network component or node, such as an RNC 30.

FIG. 1 shows that the HSDPA terminal 10 includes a suitable wireless transceiver 12 coupled to at least one antenna 13. The transceiver 12 is further coupled to at least one data processor (DP) 14 that in turn includes or is coupled to a volatile and/or non-volatile memory 16. The memory 16 stores program code that is executable by the DP 14 to operate with the Node-B 20. The Node-B 20 is constructed to include a transceiver 22 coupled to at least one antenna 23. The Node-B 20 is also assumed to include at least one DP 24 that in turn includes or is coupled to a volatile and/or non-volatile memory 26. The memory 26 stores program code that is executable by the DP 24 to operate with the UE 10, including program code 26A that is provided to implement the Node-B 20 aspects of this invention. The Node-B 20 and the UE 10 communicate via a wireless link 15, which is assumed to convey at least in part the HS-DSCH. The RNC 30 includes an interface (I/F) 32 for coupling to the Node-B 20, and is also assumed to include at least one DP 34 that in turn includes or is coupled to a volatile and/or non-volatile memory 36. The memory 36 stores program code that is executable by the DP 34 to operate with the Node-B 20.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by at least the DP 24 of the Node-B 20, or by hardware, or by a combination of software and hardware..

The memories 16, 26 and 36 may be of any type suitable to the local technical environment and may be implemented using any suitable data storage technology, such as semiconductor-based memory devices, magnetic memory devices and systems, optical memory devices and systems, fixed memory and removable memory. The DPs 14,24 and 34 may be of any type suitable to the local technical environment, and may include one or more of general purpose computers, special purpose computers, microprocessors, digital signal processors (DSPs) and processors based on a multi-core processor architecture, as non-limiting examples.

In accordance with the exemplary embodiments of this invention there is described a method for the Node-B 20 to estimate the HS-DSCH required power for each RRI period (using a minimum averaging period of, for example, 100 ms). Assume that a HSDPA user number k is scheduled in M TTIs during a recent RRI period of N TTIs, i.e. M≦N. The effective average power used by the k-th user can then be expressed as:

$${P}_{k} = \frac{1}{N} {\sum }_{m = 1}^{M} {P}_{k}^{′} ( m ) ,$$

where P′ₖ(m) denotes the HS-DSCH transmit power that is used by user number k for each of the M TTIs where it is scheduled. The required HS-DSCH power for SPI number x to fulfill the GBR can subsequently be approximated as:

$${P}_{SPI} ( x ) = {\sum }_{k ∈ SPI ( x )} {P}_{k} \frac{{GBR}_{k}}{{RB}_{k}} ,$$

where RBₖ is the average bit rate supported to the k-th user over the past RRI period, GBRₖ is the guaranteed bit rate for the k-th user, and SPI(x) is the set of users that have SPI=x. Users with no GBR defined (GBRₖ=void or GBRₖ=0) are preferably not taken into account when calculating P_{SPI}(x). Note that RBₖ, in principle, may be calculated as the total number of transmitted bits for which the Node-B 20 has received positive acknowledgments during one RRI period, divided by the duration of the RRI period.

Thus for user number k,

$${RB}_{k} = \frac{1}{N \cdot {T}_{TTI}} {\sum }_{m = 1}^{M} {TBS}_{k} ( m ) {A}_{k} ( m ) ,$$

where TBSₖ(m) is the transport block size for the m-th TTI where the user k is scheduled, T_{TTI} is the time duration of a HS-DSCH TTI (e.g., 2ms), and the variable Aₖ(m) equals either zero or one. If the Node-B 20 receives a positive acknowledgement for the transmission in the m-th TTI where user k was scheduled, then Aₖ(m)=1, otherwise Aₖ(m)=0.

The estimator for the HS-DSCH required power, in accordance with the exemplary embodiments of this invention, can be implemented in the Node-B 20 as part of a MAC-hs entity 27. By the use ofthis invention the Node-B 20 becomes operable to report the HS-DSCH required power.

One exemplary advantage of using the estimator for the HS-DSCH required power is that it provides a technique for implementing a more intelligent implementation of QoS mechanisms for HSDPA in the RNC 30, such as quality based HSDPA access algorithms (e.g., load dependent HSDPA admission control) that would be executed by the DP 34.

Based on the foregoing it should be apparent that the exemplary embodiments of this invention provide a method, apparatus and computer program product(s) to estimate the HS-DSCH required power.

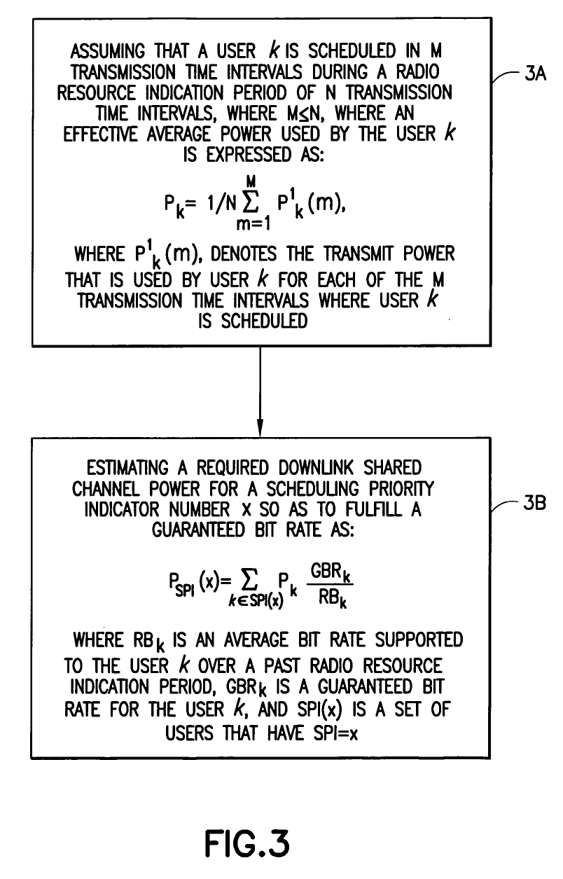

Based on the foregoing, and referring to FIG. 3, it should be appreciated that an aspect of the exemplary embodiments of this invention is a method that includes (Block 3A) assuming that a user k is scheduled in M transmission time intervals during a radio resource indication period of N transmission time intervals, where M≦N, where an effective average power used by the user k is expressed as:

$${P}_{k} = \frac{1}{N} {\sum }_{m = 1}^{M} {P}_{k}^{′} ( m ) ,$$

where P′ₖ(m) denotes the transmit power that is used by user k for each of the M transmission time intervals where user k is scheduled; and (Block 3B) estimating a required downlink shared channel power for a scheduling priority indicator number x so as to fulfill a guaranteed bit rate as:

$${P}_{SPI} ( x ) = {\sum }_{k ∈ SPI ( x )} {P}_{k} \frac{{GBR}_{k}}{{RB}_{k}} ,$$

where RBₖ is an average bit rate supported to the user k over a past radio resource indication period, GBRₖ is a guaranteed bit rate for the user k, and SPI(x) is a set of users that have SPI=x.

The logic flow diagram is also expressive of the operation of a computer program product 26A stored in the memory 26 of the base station (Node-B 20) and executed by the DP 24. The computer program product may 26A may be a part of, or coupled to, the above referenced MAC-hs entity 27.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

1. A method, comprising:
assuming that a user k is scheduled in M transmission time intervals during a radio resource indication period of N transmission time intervals, where M≦N, where an effective average power used by the user k is expressed as:
$${P}_{k} = \frac{1}{N} {\sum }_{m = 1}^{M} {P}_{k}^{′} ( m ) ,$$
where P′ₖ(m) denotes the transmit power that is used by user k for each of the M transmission time intervals where user k is scheduled; and
estimating a required downlink shared channel power for a scheduling priority indicator number x so as to fulfill a guaranteed bit rate as:
$${P}_{SPI} ( x ) = {\sum }_{k ∈ SPI ( x )} {P}_{k} \frac{{GBR}_{k}}{{RB}_{k}} ,$$
where RBₖ is an average bit rate supported to the user k over a past radio resource indication period, GBRₖ is a guaranteed bit rate for the user k, and SPI(x) is a set of users that have SPI=x.

2. The method of claim 1, where users having no defined GBR are not taken into account when calculating P_{spI}(x).

3. The method of claim 1, where RBₖ is calculated by considering a total number of transmitted bits for which a network node has received positive acknowledgments during one radio resource indication period, divided by a duration of the radio resource indication period.

4. The method of claim 1, where for the user k,
$${RB}_{k} = \frac{1}{N \cdot {T}_{TTI}} {\sum }_{m = 1}^{M} {TBS}_{k} ( m ) {A}_{k} ( m ) ,$$
where TBSₖ(m) is a transport block size for the m-th transmission time interval where the user k is scheduled, T_{TTI} is the time duration of the transmission time interval, and Aₖ (m) equals either one or zero for indicating that a network node received a positive acknowledgement for a transmission in the m-th transmission time interval where user k was scheduled, or that the network node did not receiver a positive acknowledgement for a transmission in the m-th transmission time interval where user k was scheduled, respectively.

5. The method of claim 1, performed in a wireless network node.

6. The method of claim 1, performed in a base station.

7. The method of claim 6, performed in a medium access control entity of the base station, further comprising reporting the downlink shared channel power.

8. The method of claim 1, where the required downlink shared channel power is estimated for each radio resource indication period using a minimum averaging period.

9. The method as in claim 8, where the minimum averaging period is 100 ms.

10. A computer program product stored in a tangible memory medium and comprising program instructions, the execution of which by a data processor result in operations comprising:
for an assumption that a user k is scheduled in M transmission time intervals during a radio resource indication period of N transmission time intervals, where M≦N, where an effective average power used by the user k is expressed as:
$${P}_{k} = \frac{1}{N} {\sum }_{m = 1}^{M} {P}_{k}^{′} ( m ) ,$$
where P′ₖ(m) denotes the transmit power that is used by user k for each of the M transmission time intervals where user k is scheduled; estimating a required downlink shared channel power for a scheduling priority indicator number x so as to fulfill a guaranteed bit rate as:
$${P}_{SPI} ( x ) = {\sum }_{k ∈ SPI ( x )} {P}_{k} \frac{{GBR}_{k}}{{RB}_{k}} ,$$
where RBₖ is an average bit rate supported to the user k over a past radio resource indication period, GBRₖ is a guaranteed bit rate for the user k, and SPI(x) is a set of users that have SPI=x.

11. The computer program product of claim 10, where users having no defined GBR are not taken into account when calculating P_{spI}(x).

12. The computer program product of claim 10, where RBₖ is calculated by considering a total number of transmitted bits for which a network node has received positive acknowledgments during one radio resource indication period, divided by a duration of the radio resource indication period.

13. The computer program product of claim 10, where for the user k,
$${RB}_{k} = \frac{1}{N \cdot {T}_{TTI}} {\sum }_{m = 1}^{M} {TBS}_{k} ( m ) {A}_{k} ( m ) ,$$
where TBSₖ(m) is a transport block size for the m-th transmission time interval where the user k is scheduled, T_{TTI} is the time duration of the transmission time interval, and Aₖ(m) equals either one or zero for indicating that a network node received a positive acknowledgement for a transmission in the m-th transmission time interval where user k was scheduled, or that the network node did not receiver a positive acknowledgement for a transmission in the m-th transmission time interval where user k was scheduled, respectively.

14. The computer program product of claim 10, embodied in a wireless network node.

15. The computer program product of claim 10, embodied in a base station.

16. The computer program product of claim 15, embodied in a medium access control entity of the base station, further comprising an operation of reporting the downlink shared channel power.

17. The computer program product of claim 10, where the required downlink shared channel power is estimated for each radio resource indication period using a minimum averaging period.

18. The computer program product of claim 17, where the minimum averaging period is 100 ms.

19. Apparatus, comprising:
a wireless network node comprising an interface for coupling to a plurality of user devices and further comprising circuitry responsive to an assumption that a user k is scheduled in M transmission time intervals during a radio resource indication period of N transmission time intervals, where M≦N, where an effective average power used by the user k is expressed as:
$${P}_{k} = \frac{1}{N} {\sum }_{m = 1}^{M} {P}_{k}^{′} ( m ) ,$$
where P′ₖ(m) denotes the transmit power that is used by user k for each of the M transmission time intervals where user k is scheduled, to estimate a required downlink shared channel power for a scheduling priority indicator number x so as to fulfill a guaranteed bit rate as:
$${P}_{SPI} ( x ) = {\sum }_{k ∈ SPI ( x )} {P}_{k} \frac{{GBR}_{k}}{{RB}_{k}} ,$$
where RBₖ is an average bit rate supported to the user k over a past radio resource indication period, GBRₖ is a guaranteed bit rate for the user k, and SPI(x) is a set of users that have SPI=x.

20. The apparatus of claim 19, where users having no defined GBR are not taken into account when calculating P_{spI}(x).

21. The apparatus of claim 19, where RBₖ is calculated by considering a total number of transmitted bits for which the network node has received positive acknowledgments during one radio resource indication period, divided by a duration of the radio resource indication period.

22. The apparatus of claim 19, where for the user k,
$${RB}_{k} = \frac{1}{N \cdot {T}_{TTI}} {\sum }_{m = 1}^{M} {TBS}_{k} ( m ) {A}_{k} ( m ) ,$$
where TBSₖ(m) is a transport block size for the m-th transmission time interval where the user k is scheduled, T_{TTI} is the time duration of the transmission time interval, and Aₖ(m) equals either one or zero for indicating that the network node received a positive acknowledgement for a transmission in the m-th transmission time interval where user k was scheduled, or that the network node did not receiver a positive acknowledgement for a transmission in the m-th transmission time interval where user k was scheduled, respectively.

23. The apparatus of claim 19, where the network node comprises a base station.

24. The apparatus of claim 23, where the circuitry forms a part of a medium access control entity of the base station, further comprising means for reporting the downlink shared channel power.

25. The apparatus of claim 19, where the circuitry is embodied at least partially in at least one integrated circuit.

26. The apparatus of claim 19, where the required downlink shared channel power is estimated for each radio resource indication period using a minimum averaging period.

27. The apparatus of claim 26, where the minimum averaging period is 100 ms.

28. Apparatus, comprising:
circuitry responsive to an assumption that a user k is scheduled in M transmission time intervals during a radio resource indication period of N transmission time intervals, where M≦N, where an effective average power used by the user k is expressed as:
$${P}_{k} = \frac{1}{N} {\sum }_{m = 1}^{M} {P}_{k}^{′} ( m ) ,$$
where P′ₖ(m) denotes the transmit power that is used by user k for each of the M transmission time intervals where user k is scheduled, to estimate a required downlink shared channel power for a scheduling priority indicator number x so as to fulfill a guaranteed bit rate as:
$${P}_{SPI} ( x ) = {\sum }_{k ∈ SPI ( x )} {P}_{k} \frac{{GBR}_{k}}{{RB}_{k}} ,$$
where RBₖ is an average bit rate supported to the user k over a past radio resource indication period, GBRₖ is a guaranteed bit rate for the user k, and SPI(x) is a set of users that have SPI=x.

29. The apparatus of claim 28, where a user having no defined GBR is not taken into account when calculating P_{spI}(x).

30. The apparatus of claim 28, where RBₖ is calculated by considering a total number of transmitted bits for which positive acknowledgments are received during one radio resource indication period, divided by a duration of the radio resource indication period.

31. The apparatus of claim 28, where for the user k,
$${RB}_{k} = \frac{1}{N \cdot {T}_{TTI}} {\sum }_{m = 1}^{M} {TBS}_{k} ( m ) {A}_{k} ( m ) ,$$
where TBSₖ(m) is a transport block size for the m-th transmission time interval where the user k is scheduled, T_{TTI} is the time duration of the transmission time interval, and Aₖ(m) equals either one or zero for indicating that a positive acknowledgement has been received for a transmission in the m-th transmission time interval where user k was scheduled, or that a positive acknowledgement was not received for a transmission in the m-th transmission time interval where user k was scheduled, respectively.

32. The apparatus of claim 28, where the circuitry is embodied at least partially in at least one integrated circuit.

33. Apparatus, comprising:
means for bidirectionally coupling to a plurality of users; and
means, responsive to an assumption that a user k is scheduled in M transmission time intervals during a radio resource indication period of N transmission time intervals, where M≦N, where an effective average power used by the user k is expressed as:
$${P}_{k} = \frac{1}{N} {\sum }_{m = 1}^{M} {P}_{k}^{′} ( m ) ,$$
where P′ₖ(m) denotes the transmit power that is used by user k for each of the M transmission time intervals where user k is scheduled, for estimating a required downlink shared channel power for a scheduling priority indicator number x so as to fulfill a guaranteed bit rate as:
$${P}_{SPI} ( x ) = {\sum }_{k ∈ SPI ( x )} {P}_{k} \frac{{GBR}_{k}}{{RB}_{k}} ,$$
where RBₖ is an average bit rate supported to the user k over a past radio resource indication period, GBRₖ is a guaranteed bit rate for the user k, and SPI(x) is a set of users that have SPI=x.

34. The apparatus of claim 33 where, for the user k,
$${RB}_{k} = \frac{1}{N \cdot {T}_{TTI}} {\sum }_{m = 1}^{M} {TBS}_{k} ( m ) {A}_{k} ( m ) ,$$
where TBSₖ(m) is a transport block size for the m-th transmission time interval where the user k is scheduled, T_{TTI} is the time duration of the transmission time interval, and Aₖ(m) equals either one or zero for indicating that a positive acknowledgement has been received via said coupling means for a transmission in the m-th transmission time interval where user k was scheduled, or that a positive acknowledgement was not received via said coupling means for a transmission in the m-th transmission time interval where user k was scheduled, respectively.
